(19) United States
(12) Patent Application Publication
(10) Pub. No.: US 2003/0025326 A1
(43) Pub. Date: Feb. 6, 2003

(54) Sliding coupling for gas appliances

(75) Inventor: Clyde R. Schulte, Wichita, KS (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: The Coleman Company, Inc.

(21) Appl. No.: 09/915,040

(22) Filed: Jul. 25, 2001

(51) Int. Cl. F16L 37/18

(52) U.S. Cl. 285/316; 285/320; 285/86

(57) ABSTRACT

A quickly connectable, coupling for attaching a gas source to a gas appliance. The coupling fits onto a gas probe having a nipple, and a shoulder located behind the nipple. The coupling includes a slide that is movable between an opened position and a closed position. Moving the slide back and forth causes an inwardly-directed protrusion to move radially inward and outward. To secure the coupling on the probe, the slide is moved to cause the inwardly-directed protrusion to move radially inward behind the shoulder. The coupling includes a check valve that is spring-biased to prevent the flow of gas through the coupling when the coupling is not attached to the probe. When inserted in the coupling, the probe contacts a shaft of the check valve, and presses the check valve, against the bias of the spring, to an opened position.

### FIELD OF THE INVENTION

The present invention relates generally to gas appliances, and more particularly to a coupling for attaching a gas line to a gas appliance.

### BACKGROUND OF THE INVENTION

Portable camp stoves are often used by campers for preparing foods at a camp site. Typically, such camp stoves include a pair of burners, a fuel supply, and collapsible shield to screen three sides of the stove from wind. The collapsible shield usually is a top for the stove and two side panels. The fuel supply is typically either kerosene or propane.

To store the camp stoves, the side panels are folded to the top panel, and the top is folded over the stove burners. The burners are usually mounted within a housing, and closing the top over the housing forms a box-like enclosure around the burners. The enclosure may then be stored in a cardboard box, or may be stored as is. The fuel supply, which is typically attached to a gas conduit for the burners, is disconnected from the gas conduit for storage. Kerosene camp stoves typically include a metal rod extending from a kerosene tank. The metal rod is attached to the gas conduit, for example by threading the end of the rod onto a connection. The kerosene tank is mounted on the stove, for example along the front of the stove.

For camp stoves that utilize propane, the connection is more complicated. A regulator is used to drop the pressure of the gas from bottle pressure to appliance pressure. The propane bottle is attached to the regulator, usually by threading it onto the regulator. To assure that most of the propane in the tank may be used, the tank is mounted at an angle, e.g., 20 degrees to horizontal.

Preferably, the regulator is mounted to the camp stove so that the bottle may be supported at the preferred angle. This may involve, for example, mounting the regulator at a sufficient height from the bottom of the camp stove so that a bottle attached to the regulator may rest on a surface on which the camp stove is sitting and thereby extends at the proper angle. As such, the structure between the regulator and the gas conduit for the stove should be fairly rigid so that the bottle may be supported. The regulator must also extend outside the enclosure for the camp stove, so that the propane bottle is removed from the heat of the stove.

The regulator structure may present a problem when a user attempts to store the camp stove. As described above, camp stoves are usually designed so that they fold into a compact, box-like configuration. If the regulator remains attached to the outside of the burner enclosure, the enclosure may be difficult to pack efficiently, or the regulator may be damaged as it is being put away.

### SUMMARY OF THE INVENTION

The present invention provides a quick-disconnect coupling for attaching a gas source to a gas appliance. The gas source may be, for example, a propane tank or bottle, or a regulator that is designed to be attached to a propane tank or bottle. The gas appliance may be, for example, a camp stove. The quick disconnect permits, for example, a regulator to be removed from the outside of a camp stove enclosure so that the camp stove may be more conveniently stored.

The coupling is designed to secure to a probe. The probe includes a nipple onto which the coupling is fitted, and a shoulder, located in one embodiment behind the nipple. The coupling includes a slide that is movable between an opened position and a closed position. The slide is operatively connected to at least one spring clip arm. The spring clip arm includes an inwardly-directed protrusion. The protrusion may be, for example, the bent end of a metal leaf spring. Moving the slide back and forth causes the inwardly-directed protrusion to move radially inward and outward.

To secure the coupling on the probe, the slide is moved to cause the inwardly-directed protrusion to move radially outward, and the coupling is placed over the nipple. The slide is then moved in the opposite direction to cause the inwardly-directed protrusion to move radially inward. Preferably, the inwardly-directed protrusion aligns just outside the shoulder, and the abutment of the inwardly-directed protrusion with the shoulder prevents the coupling from being removed from the probe. Alternatively, the nipple and the slide may be configured so that the coupling may be placed on the nipple, and the inwardly-directed protrusion engages the coupling and causes the slide to detract, allowing the coupling to be inserted.

In accordance with another aspect of the present invention, the coupling includes a check valve that is spring-biased to prevent the flow of gas through the coupling when the coupling is not attached to the probe. When inserted in the coupling, the probe contacts a shaft of the check valve, and presses the check valve, against the bias of the spring, to an opened position. When the probe is removed, the spring presses the check valve back into position and closes the gas flow.

The present invention provides a quickly connectable, stable connection for gas lines. By shifting the slide, the coupling easily slides onto a probe. In one movement the coupling is inserted over the nipple of the probe and the flow of gas is opened out of the coupling and into the probe. The slide may be shifted, or may be allowed to return to its original position by the bias of a spring so as to cause the inwardly-directed protrusion to lock within the shoulder of the probe.

Other advantages will become apparent from the following detailed description when taken in conjunction with the drawings, in which:

### BRIEF DESCRIPTION OF THE DRAWINGS

FIG. 1 is a top perspective view of a camp stove, having attached thereto a propane regulator and associated piping that is connected to the camp stove using a coupling formed in accordance with one aspect of the present invention;

FIG. 2 is a bottom, partial cutaway view of the camp stove of FIG. 1, showing attachment of the coupling to a probe extending from a gas conduit of the camp stove;

FIG. 3 is a side perspective view of the propane regulator, associated piping, and the coupling of FIGS. 1 and 2, showing opened and closed positions of the coupling;

FIG. 4 is an exploded perspective view of the propane regulator, associated piping, and the coupling of FIG. 3;

FIG. 5 is a cross-sectional view of the propane regulator, associated piping, and the coupling of FIG. 3, showing the coupling in an opened position; and

FIG. 6 is a cross-sectional view of the propane regulator, associated piping, and the coupling of FIG. 3, similar to FIG. 5, but showing the coupling in a closed, locked position.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. In addition, to the extent directional references are used, such as top, bottom, forward, rearward, or the like, the references are for ease of illustration, and a person of skill in the art may reorient the elements of the invention as necessary. Furthermore, well-known features may be omitted or simplified in order not to obscure the present invention.

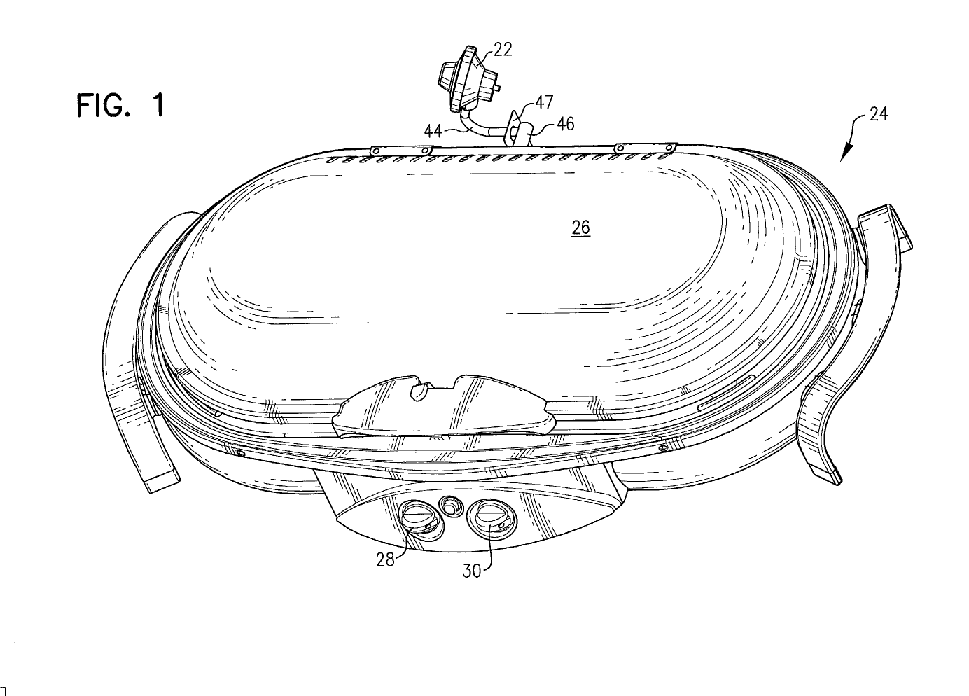

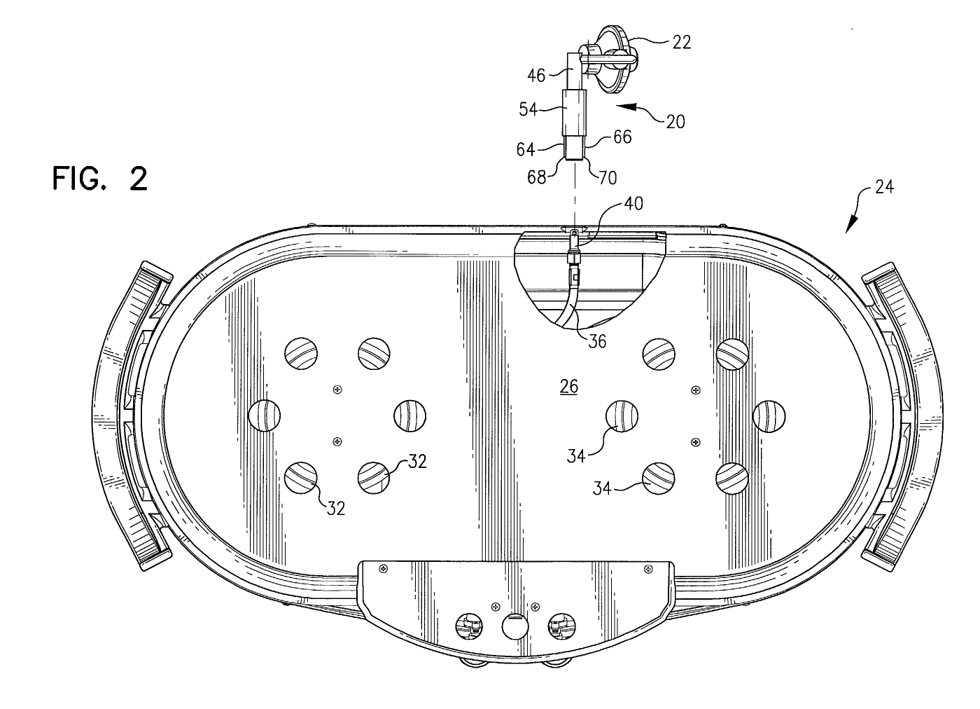

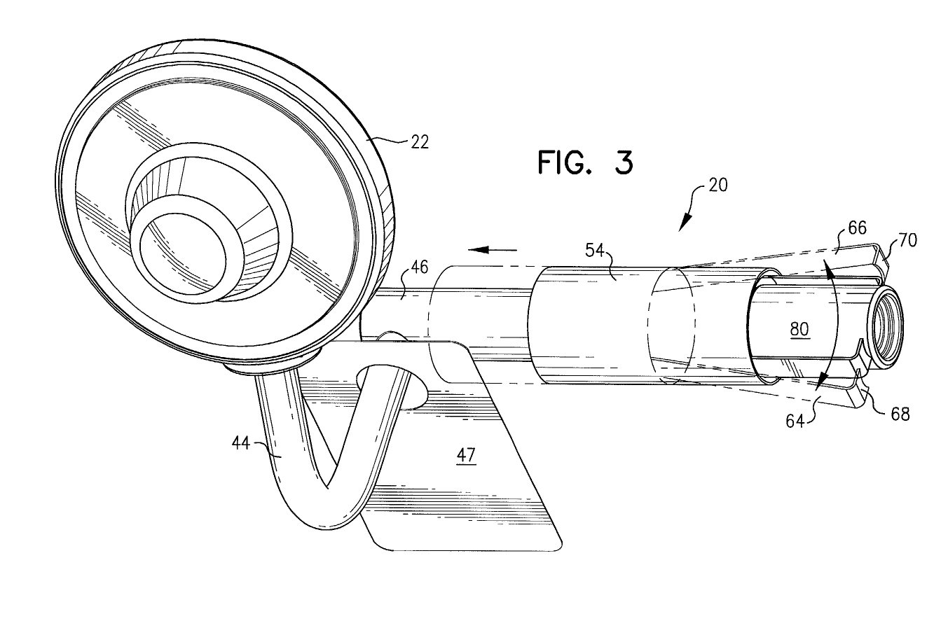

Briefly described, the present invention provides a coupling 20 (FIG. 3) for attaching a gas source to a gas appliance. The gas source may be, for example, a propane tank or bottle, or, as shown in FIGS. 1 and 2, a regulator 22 that is designed to be attached to a propane tank or bottle (not shown). As is known, a regulator reduces gas pressure from a gas source to an appliance-operating level.

The gas appliance may be any gas appliance, or a gas line connected to multiple gas appliances. As one example, the gas appliance may be a camp stove 24 such as is shown in FIGS. 1 and 2. The camp stove 24 shown in the drawing includes an outer enclosure 26 having knob controls 28, 30 thereon for operating an internal pair of burners 32, 34 (only a portion of which is shown through vent holes in FIG. 2, but the structure and operation of which is known). The burners 32, 34 are connected by a gas conduit 36 (FIG. 2) to a gas probe 40. The gas probe 40 is configured for attachment to the coupling 20, as is further described below.

Turning now to FIG. 3, the regulator 22 is in fluid communication with the coupling 20 via a regulator tube 42. For ease of description only, the regulator side of the regulator tube 42 (i.e., the left side of FIG. 3), and components attached thereto, is herein referred to as a “rearward” side of the respective component, and the opposite side (i.e., the coupling end, to the right in FIG. 3) is referred to herein as the “forward” side.

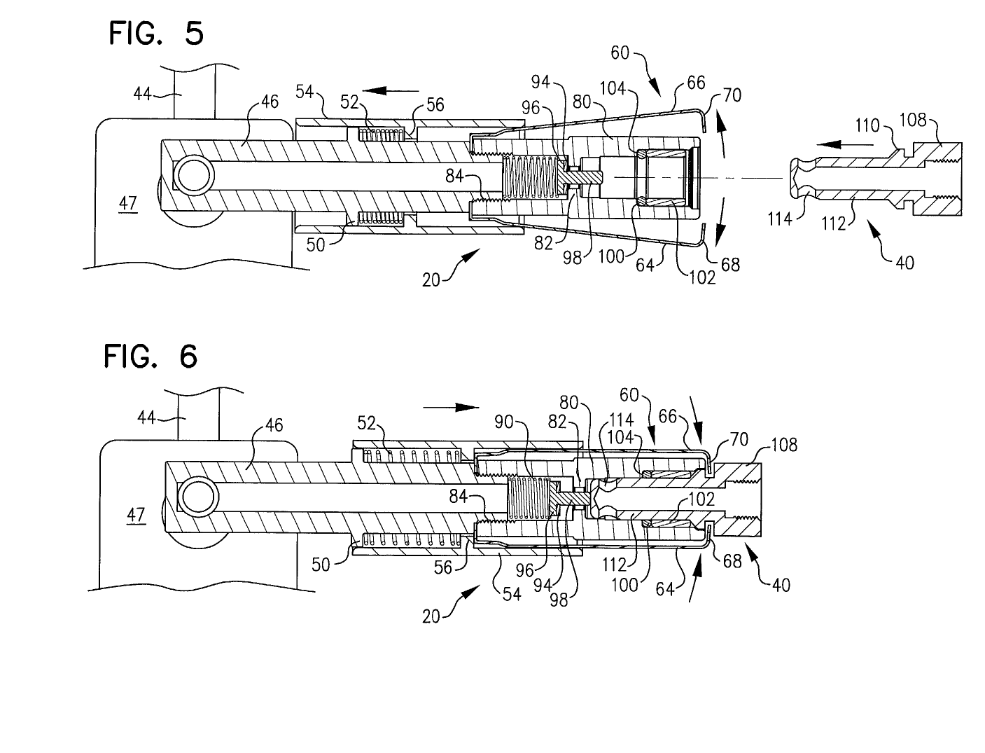

The regulator tube 42 includes a conduit 44 extending upward to the regulator 22, and a connector tube 46 that is attached at its rearward end to the conduit 44. The connector tube 46 and the conduit 44 are hollow, and the conduit is welded to a hole in the connector tube so that the two elements are in fluid communication with one another. The regulator 22 is attached (e.g., by threading onto threads) to the opposite end of the conduit. As can be seen in FIG. 5, the rearward end of the connector tube 46 is closed, so that a closed fluid conduit is formed between the forward end of the connector tube and the regulator 22. The connector tube 46 and the conduit 44 may be formed of metal (wherein the two elements are welded or otherwise suitably attached to one another), or any other suitable material. A hang tag 47 extends around and hangs from the conduit 44.

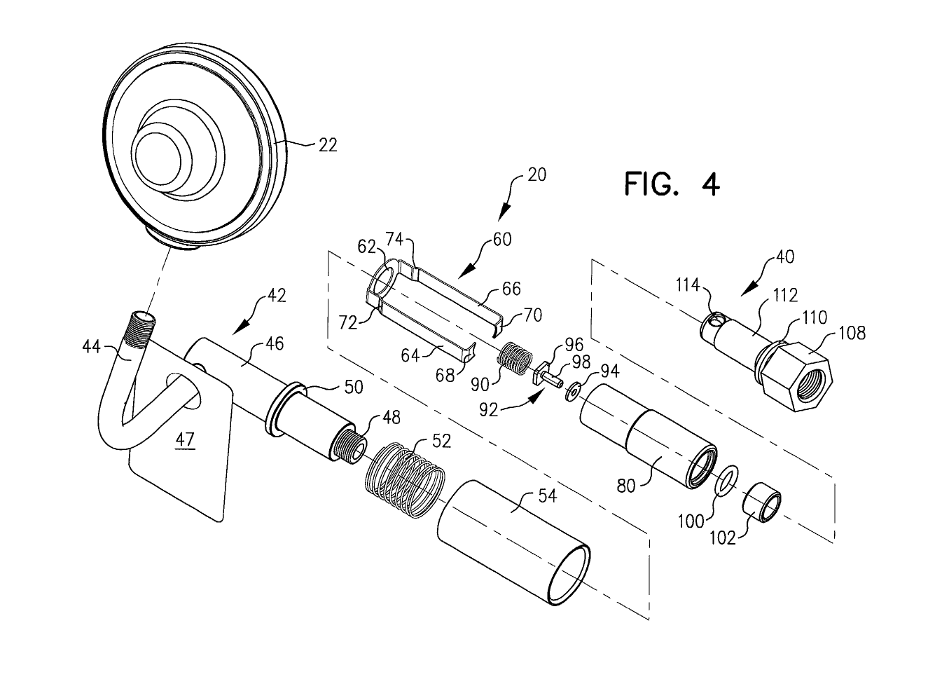

The connector tube 46 includes a set of external threads 48 (FIG. 4) at its forward end. The external threads 48 are spaced radially inward from the remainder of the width of the connector tube 46. A shoulder 50, shaped in the form of an annular ring, is spaced rearwardly from the external threads 48.

A slide spring 52 is sized to fit over the portion of the connector tube 46 that is forward of the shoulder 50. A hollow, cylindrical slide 54 is configured so that a rearward cavity fits around the slide spring 52. The hollow, cylindrical slide 54 includes an internal annular ring 56 (FIG. 5) that is sized so that the slide spring 52 is captured between the internal annular ring 56 and the shoulder 50. The internal diameter of the rearward end of the hollow, cylindrical slide 54 is sized so that it fits over the shoulder 50. In addition, the internal diameter of the internal annular ring 56 is sized slightly larger than the outer circumference of the connector tube 46. The hollow, cylindrical slide 54 may be formed of steel or another suitable material.

A spring clip 60 (best shown in FIG. 4) fits partially within the forward portion of the hollow, cylindrical slide 54. The spring clip 60 includes a ring 62 that includes a hole that is sized to fit snugly around the external threads 48 of the connector tube 46. A pair of outwardly-biased spring arms 64, 66 extend outward from the ring 62. The outwardly-biased spring arms 64, 66 are rolled inward at their forward ends to form inwardly-directed protrusions 68, 70. The spring clip 60 may be formed, for example, of tempered spring steel, or any other material that permits the spring arms 64, 66 to remain outwardly biased after several cycles. The outwardly-biased spring arms 64, 66 may include a structure that causes the arms to be outwardly biased, such as bent ripples 72, 74 formed in the arms.

A hollow, cylindrically-shaped check valve connector 80 is configured to be captured between the outwardly-biased spring arms 64, 66. As can be seen in FIG. 5, the check valve connector 80 includes an internal annular ring 82 at approximately one half of its length. The check valve connector 80 additionally includes internal threads 84 at its rearward end, designed to be threaded on the external threads 48 on the forward end of the connector tube 46. Threading the check valve connector 80 onto the external threads 48 traps the ring 62 of the spring clip 62, and holds the spring clip 60 in position.

A check valve spring 90, a check valve spool 92, and a check valve washer 94 are arranged to be received in the rearward cavity of the cylindrically-shaped check valve connector 80. These elements are placed within the rearward cavity before the check valve connector 80 is threaded onto the external threads 48. The check valve spring 90 is slightly smaller in diameter than the rearward cavity. The check valve spool 92 includes a base 96 that is sized slightly smaller than the rearward cavity, and a shaft 98 that extends perpendicularly from the center of the base. The shaft 98 is slightly smaller in diameter than the internal annular ring 82 on the inside of the check valve connector 80. The check valve washer 94 is preferably rubber or another deformable material, and fits on the shaft 98, and is sized so that it is larger than the diameter of the internal annular ring 82, but slightly smaller than the inside diameter of the rearward cavity of the check valve connector 80.

In a normal position (shown in FIG. 5), the check valve spring 90 biases the check valve washer 94 against the internal annular ring 82, causing the washer and the shaft 98 to close the opening within the internal annular ring. This closure prevents gas in the connector tube 46 from flowing out of the connector 20 when the connector is not connected to the probe 40.

An O-ring 100 and a sleeve 102 fit in the forward cavity of the check valve connector 80. The sleeve 102 is press fit into place at the forward end of the check valve connector 80, and holds the O-ring 100 in place against a shoulder 104 inside the forward cavity of the check valve connector.

The gas probe 40 includes an integral nut 108 at a forward end, a shoulder 110 spaced slightly inward of the integral nut 108, and a nipple 112 extending rearwardly of the shoulder 110. A hole 114 extends perpendicularly through the forward end of the nipple 112.

As can be seen in FIG. 6, when assembled, the hollow, cylindrical slide 54 is biased forward by the slide spring 52. The internal annular ring 56 is pressed against the ring 62 of the spring clip 60, defining a limit to forward sliding movement of the hollow, cylindrical slide 54. When in the forward position, the outwardly-biased spring arms 64, 66 are pressed inward by the forward ends of the hollow, cylindrical slide 54. In this position, the inwardly-directed protrusions 68, 70 are pressed inward, and are locked into position by the forward ends of the hollow, cylindrical slide 54 pressing the outer surfaces of the outwardly-biased spring arms 64, 66.

If it is desired to attach the coupling 20 to the probe 40, a user grabs the outer surface of the hollow, cylindrical slide 54 and slides it rearward, as shown by the arrows in FIGS. 3 and 5. Knurls (not shown), or another roughened surface, may be provided to aid in gripping of the hollow, cylindrical slide 54.

As the hollow, cylindrical slide 54 is moved rearward, the outwardly-biased spring arms 64, 66 are released from their grasp by the check valve connector 80, and flare outward (shown in phantom in FIG. 3). This movement drives the inwardly-directed protrusions 68, 70 radially outward as is shown in FIG. 5. The inwardly-directed protrusions 68, 70 are thus removed from the forward cavity of the check valve connector 80, permitting attachment of the coupling 40 to the probe 40.

With the hollow, cylindrical slide 54 in the retracted position, the forward cavity of the check valve connector 80 is fitted over the nipple 112 of the probe 40. As can be seen in FIG. 6, the nipple extends into the forward cavity and is tightly surrounded by the O-ring 100. The forward end of the nipple 112 contacts the shaft 98 of the check valve spool 92, and presses the check valve spool, against the bias of the check valve spring 90, rearward in the check valve connector 80. As the check valve spool 92 moves rearward, the check valve washer 94 disengages the sides of the internal annular ring 82 of the check valve connector 80, and opens a passageway between the regulator 22 and the interior of the probe 40. Specifically, gas flowing from the regulator 22 may flow through the conduit 44 and the connector tube 46, around the check valve spool 92 and check valve washer 94, out of the hole defined by the internal annular ring 82 of the check valve connector 80, and into the hole 114 on the nipple 112 of the probe 40. The gas is prevented from flowing out of the connection of the probe 40 and the connector 20 by the tight fit of the nipple in the O-ring 100.

In practice, the connector 20 may often be placed on the probe 40 without gas being present in the regulator tube 42. For example, the regulator 22, regulator tube 42, and the connector 20 may be attached to the camp stove 24 prior to the regulator being attached to a propane bottle or tank. However, if gas pressure were present at the connector 20, the check valve of the present invention prevents the flow of gas through the coupling 20 when the coupling is not attached to the probe.

After the coupling 20 is inserted onto the probe, the hollow, cylindrical slide 54 is moved forward, as indicated by the arrow in FIG. 6, either by physically pushing the hollow, cylindrical slide forward, or by releasing the hollow, cylindrical slide and allowing the slide spring 52 to push it forward. The forward movement of the hollow, cylindrical slide 54 causes the forward end of the outwardly-biased spring arms 64, 66 to be pressed radially inward, which in turn directs the inwardly-directed protrusions 68, 70 radially inward. The inwardly-directed protrusions 68, 70 align just outside the shoulder 110, and the abutment of the inwardly-directed protrusion with the shoulder prevents the coupling 20 from being removed from the probe 40. The inwardly-directed protrusions 68, 70 are locked in place by the internal surfaces of the hollow, cylindrical slide 54 pressing the outwardly-biased spring arms 64, 66 against the sides of the check valve connector 80, and the hollow, cylindrical slide 54, in turn, is held into position by the slide spring 52. This arrangement assures that the coupling 20 is locked onto the probe 40, and prevents accidental removal of the coupling from the probe.

The shape of the nipple 112 also permits the coupling 20 to be attached without manually retracting the hollow, cylindrical slide 54. To this end, the nipple 112 includes a sloped forward surface that permits the inwardly-directed protrusions 68, 70 to slide along the surface and drive the outwardly-biased spring arms 64, 66 outward, and the hollow, cylindrical slide 54 rearward. This action continues until the inwardly-directed protrusions 68, 70 slide over the shoulder 110, where the bias of the slide spring 52 drives the hollow, cylindrical slide 54 forward, locking the inwardly-directed protrusions 68, 70 behind the shoulder 110.

To remove the coupling 20 from the probe 40, the hollow, cylindrical slide 54 is grasped by a user and slid rearward as shown in FIG. 5. The inwardly-directed protrusions 68, 70 release from the shoulder 110, allowing the coupling 20 to be pulled off the probe 40. As the probe 40 is removed, the check valve spool 92 is pressed forward, causing the check valve washer 94 to engage with the internal annular ring 82 on the check valve connector 80. Gas in the connector tube 46 is thus prevented from escaping the coupling 20.

The present invention provides a quickly connectable, stable connection for gas lines. By shifting the hollow, cylindrical slide 54, the coupling 20 may be slid onto the probe 40, and in one movement the coupling is inserted over the nipple 112 of the probe and the flow of gas is opened out of the coupling and into the probe (i.e., by the opening of the check valve). The hollow, cylindrical slide 54 may be shifted or release against the bias of a slide spring 52 so as to cause the inwardly-directed protrusions 68, 70 to lock on the shoulder 110 of the probe 40.

Variations are possible. For example, the spring clip 60 may have only one outwardly-biased spring arm 64, and one inwardly-directed protrusion 68. Alternatively, another mechanism may be used to selectively bias an inwardly-directed protrusion inward. In addition, the shoulder 110 may be arranged on other places on the probe 40.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A coupling for attaching a gas source to a gas appliance, comprising:
a housing;
an opening in the housing for fitting onto a gas probe, the gas probe including a shoulder;
a slide mounted on the housing that is movable between an opened position and a closed position; and
a protrusion operatively connected to the slide so that the protrusion moves radially inward relative to the opening as the slide is moved from the opened position and the closed position, the protrusion being arranged so that, when the slide is in the closed position, the protrusion extends behind the shoulder of a gas probe that is inserted into the opening, and when the slide is in the opened position, the protrusion is removed from behind the shoulder of a gas probe that is inserted into the opening.

2. The coupling of claim 1, wherein the protrusion is connected to a forward portion of a first spring arm, and wherein the forward portion of the first spring arm moves radially inward relative to the opening when the slide is moved from the opened position and the closed position, causing the protrusion to extend behind the shoulder of a gas probe that is inserted into the opening.

3. The coupling of claim 2, wherein the first spring arm comprises a bias radially outward relative to the opening, and wherein when slide is in the opened position, the bias radially outward causes the protrusion to be removed from behind the shoulder of a gas probe that is inserted into the opening.

4. The coupling of claim 2, further comprising a second spring arm and a second protrusion connected to a forward portion of the second spring arm, and wherein the forward portion of the second spring arm moves radially inward relative to the opening when the slide is moved from the opened position to the closed position, causing the second protrusion to extend behind the shoulder of a gas probe that is inserted into the opening.

5. The coupling of claim 4, wherein the second spring arm comprises a bias radially outward relative to the opening, and wherein when slide is in the opened position, the bias radially outward causes the second protrusion to be removed from behind the shoulder of a gas probe that is inserted into the opening.

6. The coupling of claim 4, wherein the first spring arm and the second spring arm comprise an integral spring clip.

7. The coupling of claim 1, wherein the slide is biased to the closed position.

8. The coupling of claim 7, wherein the slide is biased to the closed position by a spring.

9. The coupling of claim 1, wherein the opening defines a longitudinal axis, and wherein movement of the slide between the opened position and the closed position is parallel to the longitudinal axis.

10. The coupling of claim 1, further comprising valve that is configured in a closed position to prevent the flow of gas through the coupling when the coupling is not attached to a probe.

11. The coupling of claim 10, wherein the valve is biased to the closed position.

12. The coupling of claim 11, wherein the valve is biased to the closed position by a spring.

13. The coupling of claim 10, wherein the valve comprises a shaft, and wherein when the coupling is inserted onto a probe, the probe contacts a shaft of the check valve, and presses the shaft and so that the check valve is in an opened position.

14. The coupling of claim 13, wherein the valve is biased to the closed position.

15. The coupling of claim 14, wherein the valve is biased to the closed position by a spring.

16. The coupling of claim 1, wherein the moving the protrusion outward moves the slide from the closed position towards the opened position.

17. A coupling for attaching a gas source to a gas appliance, comprising:
a housing;
an opening in the housing for fitting onto a gas probe, the opening defining a longitudinal axis and the gas probe including a shoulder;
a slide that is movable parallel to the longitudinal axis between an opened position and a closed position;
a first arm operatively connected to the slide so that a forward part of the first arm moves radially inward relative to the opening as the slide is moved from the opened position and the closed position; and
a protrusion on the forward part of the arm, the protrusion being arranged so that, when the slide is in the closed position, the protrusion moves radially inward relative to the opening and extends behind the shoulder of a gas probe that is inserted into the opening, and when the slide is in the opened position, the protrusion is removed from behind the shoulder of a gas probe that is inserted into the opening.

18. The coupling of claim 17, wherein the first arm comprises a bias radially outward relative to the opening, and wherein when slide is in the opened position, the bias radially outward causes the protrusion to be removed from behind the shoulder of a gas probe that is inserted into the opening.

19. The coupling of claim 17, further comprising a second arm and a second protrusion connected to a forward portion of the second arm, and wherein the forward portion of the second spring arm moves radially inward relative to the opening when the slide is moved from the opened position to the closed position, causing the second protrusion to extend behind the shoulder of a gas probe that is inserted into the opening.

20. The coupling of claim 19, wherein the second arm comprises a bias radially outward relative to the opening, and wherein when slide is in the opened position, the bias radially outward causes the second protrusion to be removed from behind the shoulder of a gas probe that is inserted into the opening.

21. The coupling of claim 19, wherein the first arm and the second arm comprise an integral spring clip.

22. The coupling of claim 17, wherein the slide is biased to the closed position.

23. The coupling of claim 22, wherein the slide is biased to the closed position by a spring.

24. The coupling of claim 17, further comprising valve that is configured in a closed position to prevent the flow of gas through the coupling when the coupling is not attached to a probe.

25. The coupling of claim 24, wherein the valve is biased to the closed position.

26. The coupling of claim 25, wherein the valve is biased to the closed position by a spring.

27. The coupling of claim 24, wherein the valve comprises a shaft, and wherein when the coupling is inserted onto a probe, the probe contacts a shaft of the check valve, and presses the shaft so that the check valve is in an opened position.

28. The coupling of claim 27, wherein the valve is biased to the closed position.

29. The coupling of claim 28, wherein the valve is biased to the closed position by a spring.

30. The coupling of claim 17, wherein the moving the protrusion outward moves the slide from the closed position towards the opened position.
